(19) United States
(12) Patent Application Publication
(10) Pub. No.: US 2011/0129759 A1
(43) Pub. Date: Jun. 2, 2011

(54) ELECTRODE FOR POLYMER ELECTROLYTE MEMBRANE FUEL CELL AND METHOD FOR FORMING MEMBRANE-ELECTRODE ASSEMBLY USING THE SAME

(75) Inventors: In Chul Hwang, Seongnam (KR); Nak Hyun Kwon, Seoul (KR); Jae Seung Lee, Daejeon (KR)

(73) Assignee: HYUNDAI MOTOR COMPANY, Seoul (KR)

(21) Appl. No.: 12/769,119

(22) Filed: Apr. 28, 2010

(30) Foreign Application Priority Data
Nov. 30, 2009 (KR) 10-2009-0116575

(51) Int. Cl. H01M 8/10; H01M 8/04; B01J 31/06

(52) U.S. Cl. 429/483; 429/535; 502/159

(57) ABSTRACT

The present invention provides an electrode for a polymer electrolyte membrane fuel cell (PEMFC) and a method for forming a membrane-electrode assembly (MEA) using the same, in which carbon nanofibers are added to a catalyst layer to increase the mechanical strength of the catalyst layer and to maintain the thickness of the catalyst layer after operation for a long time, thus preventing a reduction in physical durability of the fuel cell, and cerium-zirconium oxide (CeZrO₄) as a radical inhibitor is added to the catalyst layer, thus preventing a reduction in chemical durability of the fuel cell. As a result, it is possible to physically and chemically increase the performance and durability of the fuel cell membrane-electrode assembly in a robust manner and minimize the reduction in performance after operation for a long time.

### CROSS-REFERENCE TO RELATED APPLICATION

This application claims under 35 U.S.C. §119(a) the benefit of Korean Patent Application No. 10-2009-0116575 filed Nov. 30, 2009, the entire contents of which are incorporated herein by reference.

### BACKGROUND

(a) Technical Field

The present disclosure relates, generally, to a membrane-electrode assembly for a fuel cell. More particularly, it relates to an electrode for a polymer electrolyte membrane fuel cell (PEMFC) and a method for forming a membrane-electrode assembly (MEA) using the same, which increases the physical durability of the fuel cell by adding carbon nanofibers and increases the chemical durability of the fuel cell by adding a radical inhibitor.

(b) Background Art

In general, a polymer electrolyte membrane fuel cell (PEMFC) has various advantages such as high energy efficiency, high current density, high power density, short start-up time, and rapid response to a load change as compared to other types of fuel cells. In particular, a PEMFC is less susceptible to a change in pressure of a reaction gas and provides output in various ranges. For these reasons, a PEMFC can be used in various applications such as a power source for zero-emission vehicles, an independent power plant, a portable power source, a military power source, etc.

Preferably, the PEMFC is a device that generates electricity with water produced by an electrochemical reaction between hydrogen and oxygen. Hydrogen supplied to an anode of the PEMFC is dissociated into hydrogen ions (protons, H⁺) and electrons (e⁻) by a catalyst. The hydrogen ions are transmitted to a cathode through an electrolyte membrane, and the electrons are transmitted to the cathode. At this time, oxygen supplied to the cathode reacts with the electrons (e⁻) transported from the anode to the cathode through an external conductor and the protons (H⁺) migrated from the anode to the cathode through the polymer electrolyte membrane to produce water and generate electric energy.

Here, the theoretical potential is 1.23 V, and the reaction scheme is as follows:

Anode: H₂→2H⁺+2e⁻

Cathode: ½O₂+2H⁺+2e⁻→H₂O

In the above-described fuel cell system, a fuel cell stack, which substantially generates electricity, has a structure in which several to several tens of unit cells each including a membrane-electrode assembly (MEA) and a separator (also referred to as a bipolar plate) are suitably stacked.

Preferably, the membrane-electrode assembly of the fuel cell stack has a structure in which the anode (also referred to as a hydrogen electrode, fuel electrode, or oxidation electrode) and the cathode (also referred to as an air electrode, oxygen electrode, or reduction electrode) are suitably attached to the polymer electrolyte membrane interposed therebetween, and the anode and cathode are suitably formed in such a manner that a catalyst layer including platinum catalyst particles of nano-size is suitably coated on an electrode backing layer such as carbon paper or carbon cloth.

Preferably, and as shown in the conceptual diagram of FIG. 4, each of the anode and the cathode includes a catalyst, in which platinum is suitably supported on carbon, and a polymer electrolyte binder, and is formed into a catalyst layer having a thickness of about 1 to 50 μm.

Further, a gas diffusion layer having fine pores and formed by coating carbon black particles on an electrode backing layer such as carbon paper or carbon cloth to uniformly supply reactants to the membrane-electrode assembly is suitably attached to each of the anode and the cathode.

Preferably, the gas diffusion electrode may be subjected to a hydrophobic process with fluorine resin so as to discharge reaction by-products such as water (H₂O) electrochemically generated in the catalyst layer of the cathode.

Meanwhile, the membrane-electrode assembly may preferably be formed in such a manner that a catalyst layer is suitably coated on a gas diffusion layer by an appropriate method and then the gas diffusion layer including the catalyst layer is thermally compressed to an electrolyte membrane. Otherwise, the membrane-electrode assembly may be formed in such a manner that a catalyst layer is coated on an electrolyte membrane and then a gas diffusion layer is bonded thereto. The gas diffusion layers in the above structures serve as a current collector at the same time.

Accordingly, the fuel cell generates high efficiency electrical energy and reaction by-products such as water by supplying hydrogen to the anode and air or oxygen to the cathode to cause the electrochemical reaction. Preferably, the electrochemical reaction between reactants occurs in the catalyst layer included in the fuel cell, and the hydrogen ions produced by the reaction are transmitted to the cathode through a polymer electrolyte (ionomer) and a polymer membrane in the catalyst layer, and the electrons are transmitted to the cathode through the GDL and the bipolar plate.

The structure of the catalyst layer is suitably determined by the electrode material, the formation method thereof, etc. Preferably, the electrode material includes a platinum catalyst that is suitably supported on carbon and a polymer electrolyte (ionomer), and the electrode may be formed by coating a catalyst layer on a gas diffusion layer, by directly coating a catalyst layer on a membrane, or by coating a catalyst layer on a release paper and then transferring the catalyst layer on a membrane.

There are many types of carbon materials for supporting platinum such as ketjen black, Vulcan XC 72, acetylene black, carbon nanotubes, etc.

Here, the conventional methods for forming the membrane-electrode assembly are described with reference to FIGS. 1 to 3. As shown in FIG. 1, an electrode is suitably formed by coating, spraying, or painting a catalyst slurry on a gas diffusion layer and then the electrode including the gas diffusion layer is thermally compressed to both side of an electrolyte membrane. As shown in FIG. 2, a membrane-electrode assembly is formed by directly spraying, coating, or painting a catalyst slurry on a polymer membrane and then is thermally compressed to a gas diffusion layer. Further, as shown in FIG. 3, an electrode is formed by spraying, coating, or painting a catalyst slurry on a release paper and transferred to a polymer membrane, and the polymer membrane including the catalyst layers is bonded to a gas diffusion layer.

Accordingly, in the case where the catalyst layer is formed on the gas diffusion layer, although it is advantageous for the formation of pores, it is not easy to form the membrane-electrode assembly, and thus this method is not suitable for the mass production of the membrane-electrode assembly.

Further, although the method of directly forming the catalyst layer on the polymer membrane is suitable for forming small-scale electrodes, it is difficult to form large-area electrodes due to deformation of the polymer membrane. For example, in the case of the method for forming the catalyst layer on the release paper and transferring the catalyst layer to the polymer membrane, the catalyst layer may be cracked depending on the thickness of the catalyst layer, the content of a binder, and the type of catalyst, which may cause the catalyst layer to be removed while it is transferred to the polymer membrane. Further, even in the case where the catalyst layer is suitably transferred to the polymer membrane, cracks are formed in the catalyst layer, and thus the polymer membrane is directly exposed to gas supply channels, thereby significantly reducing the performance and durability.

Accordingly, the durability of the membrane-electrode assembly may be reduced by the polymer electrolyte which is chemically unstable and is readily decomposed. The decomposition of the polymer electrolyte occurs both during operation and during idle operation of the fuel cell and is directly caused by hydrogen peroxide produced when oxygen or hydrogen permeates through the polymer membrane and by hydroxyl radicals (OH radicals) produced by the hydrogen peroxide produced in the oxygen electrode during the reaction. The produced hydroxyl radicals decompose functional groups (—SO₃H) at the end of the polymer electrolyte (binder) to decrease the conductivity of hydrogen ions, thus reducing the operational performance of the fuel cell.

Accordingly, there is a need in the art for new or improved polymer electrolyte membrane fuel cell (PEMFC) and a methods for forming a membrane-electrode assembly (MEA) using the same.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an electrode for a polymer electrolyte membrane fuel cell (PEMFC) and a method for forming a membrane-electrode assembly (MEA) using the same, in which carbon nanofibers are added to a catalyst layer to suitably increase the mechanical strength of the catalyst layer and to maintain the thickness of the catalyst layer after operation for a long time, thus suitably preventing a reduction in physical durability of the fuel cell, wherein cerium-zirconium oxide (CeZrO₄) as a radical inhibitor is added to the catalyst layer, thus suitably preventing a reduction in chemical durability of the fuel cell. Accordingly to preferred embodiments of the present invention, it is possible to physically and chemically increase the performance and durability of the fuel cell membrane-electrode assembly and minimize the reduction in performance after operation for a long time.

In a preferred embodiment, the present invention provides an electrode for a polymer electrolyte membrane fuel cell, the electrode including: 20 to 80 parts by weight of a hydrogen ion conductive polymer electrolyte binder with respect to 100 parts by weight of a catalyst; 1 to 60 parts by weight of carbon nanofibers; and 1 to 20 parts by weight of a radical inhibitor.

In another preferred embodiment, the carbon nanofibers may include at least one selected from the group consisting of carbon nanotubes, carbon nanowires, carbon nanohorns, and carbon nanorings, which have a diameter of 5 to 100 nm.

In another preferred embodiment, the radical inhibitor may have an average particle size of 2 to 60 nm and include at least one selected from the group consisting of cerium oxide, zirconium oxide, manganese oxide, aluminum oxide, vanadium oxide, and mixtures thereof.

In still another preferred embodiment, the catalyst may be a platinum or platinum alloy catalyst supported on a catalyst support, the catalyst support including at least one selected from the group consisting of carbon powder, carbon black, acetylene black, ketjen black, activated carbon, carbon nanotubes, carbon nanofibers, carbon nanowires, carbon nanohorns, carbon aerogels, carbon cryogels, and carbon nanorings.

In another aspect, the present invention provides a method for forming a membrane-electrode assembly, the method including: preparing a catalyst slurry to form an electrode for a fuel cell; adding 1 to 60 parts by weight of carbon nanofibers with respect to 100 parts by weight of a catalyst to the catalyst slurry, the carbon nanofibers being in a slurry state; adding 1 to 20 parts by weight of a radical inhibitor with respect to 100 parts by weight of the catalyst to the catalyst slurry, the radical inhibitor being in a solid state; drying the final catalyst slurry prepared by adding the carbon nanofibers in a slurry state and the radical inhibitor in a solid state to the catalyst slurry and by stirring the mixture, thus forming an electrode; and thermally compressing the dried electrode on a polymer membrane.

In a preferred embodiment, the carbon nanofibers may be carbon nanotubes added in an amount of 1 to 60 parts by weight with respect to 100 parts by weight of the catalyst and the radical inhibitor may be cerium-zirconium oxide added in an amount of 1 to 20 parts by weight with respect to 100 parts by weight of the catalyst.

In another preferred embodiment, the method of the present invention may further include pulverizing the catalyst slurry using a planetary bead mill to make the particle size of the catalyst smaller and more uniform.

In still another preferred embodiment, the final catalyst slurry may have a solid content of 5 to 30 wt %, the solid content being a sum of catalyst, carbon nanofibers, radical inhibitor, and ionomer.

In yet another preferred embodiment, the thermal compression may be performed at a temperature of 100 to 180° C. and a pressure of 50 to 300 kgf for 0.5 to 30 minutes.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1 to 3 are schematic diagrams illustrating conventional methods for forming a membrane-electrode assembly.

FIG. 4 is a schematic diagram showing the structure of a conventional catalyst layer.

FIG. 5 is a schematic diagram showing the structure of a catalyst layer containing carbon nanofibers in accordance with an exemplary embodiment of the present invention.

FIG. 6 is a schematic diagram showing the structure of a catalyst layer containing carbon nanofibers and cerium-zirconium oxide as a radical inhibitor in accordance with an exemplary embodiment of the present invention.

FIG. 7 is an image of the surface of a conventional electrode (magnified 500 times).

FIG. 8 is an image of the surface of an electrode in which 4 parts by weight of carbon nanofibers with respect to 100 parts by weight of a catalyst are added in accordance with an exemplary embodiment of the present invention (magnified 500 times).

FIG. 9 is an image of the surface of an electrode in which 6 parts by weight of carbon nanofibers with respect to 100 parts by weight of a catalyst are added in accordance with an exemplary embodiment of the present invention (magnified 500 times).

FIG. 10 is an image of the surface of an electrode in which 8 parts by weight of carbon nanofibers with respect to 100 parts by weight of a catalyst are added in accordance with an exemplary embodiment of the present invention (magnified 500 times).

FIG. 11 is an image of the surface of an electrode in which 6 parts by weight of carbon nanofibers with respect to 100 parts by weight of a catalyst are added in accordance with an exemplary embodiment of the present invention (magnified 10,000 times).

FIG. 12 is a magnified image of a crack of FIG. 12 (30,000 times).

FIG. 13 is a graph comparing the operational performances of membrane-electrode assemblies in accordance with Examples and Comparative Examples.

FIG. 14 is a graph illustrating a change in the durability of an electrode in which no radical inhibitor is added.

FIG. 15 is a graph illustrating a change in the durability of an electrode in which a radical inhibitor is added in accordance with the present invention.

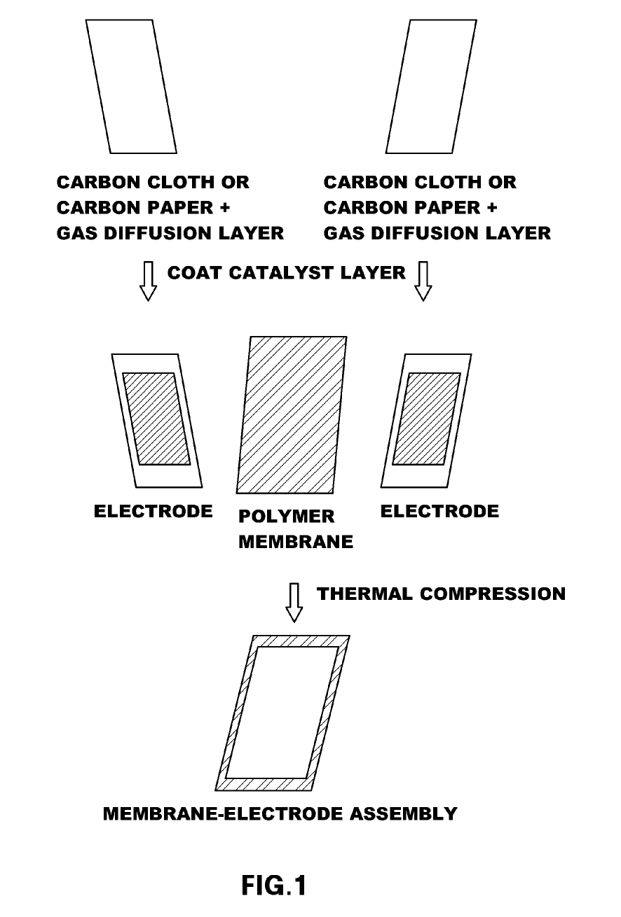

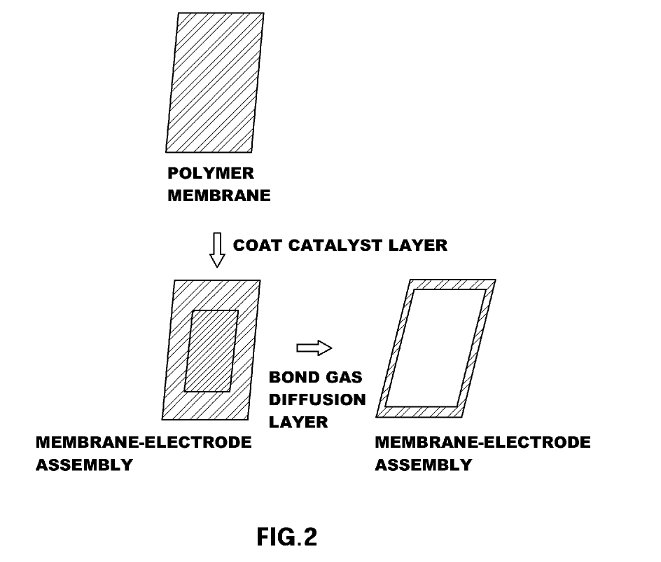

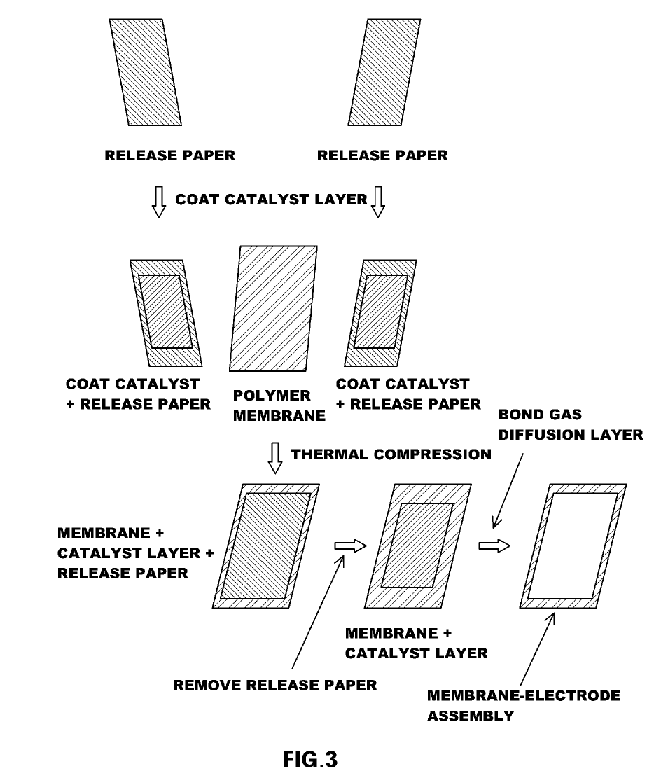

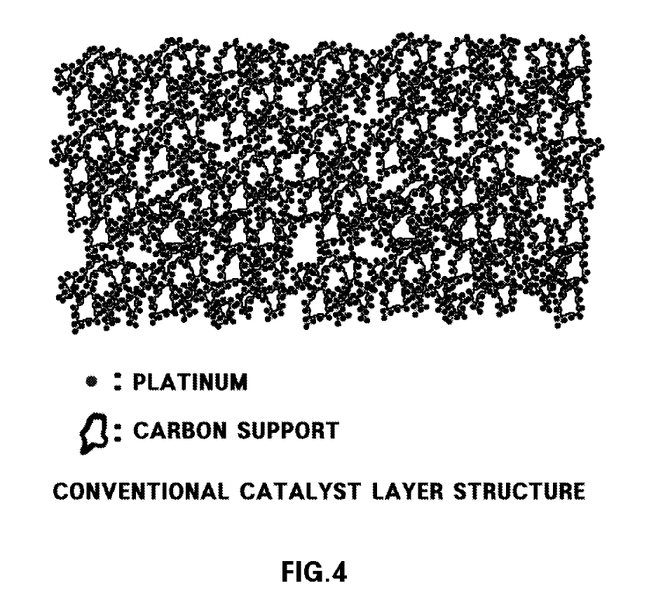

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In a preferred aspect, the present invention features an electrode for a polymer electrolyte membrane fuel cell, the electrode comprising 20 to 80 parts by weight of a hydrogen ion conductive polymer electrolyte binder with respect to 100 parts by weight of a catalyst, 1 to 60 parts by weight of carbon nanofibers; and 1 to 20 parts by weight of a radical inhibitor.

In one embodiment, the carbon nanofibers comprises at least one selected from the group consisting of carbon nanotubes, carbon nanowires, carbon nanohorns, and carbon nanorings, which have a diameter of 5 to 100 nm.

In another embodiment, the radical inhibitor has an average particle size of 2 to 60 nm and comprises at least one selected from the group consisting of cerium oxide, zirconium oxide, manganese oxide, aluminum oxide, vanadium oxide, and mixtures thereof.

In another further embodiment, the catalyst is a platinum or platinum alloy catalyst supported on a catalyst support, the catalyst support comprising at least one selected from the group consisting of carbon powder, carbon black, acetylene black, ketjen black, activated carbon, carbon nanotubes, carbon nanofibers, carbon nanowires, carbon nanohorns, carbon aerogels, carbon cryogels, and carbon nanorings.

In still another embodiment, the platinum or platinum alloy catalyst contains platinum in an amount of 5 to 80 wt %.

The invention also features a method for forming a membrane-electrode assembly, the method comprising preparing a catalyst slurry to form an electrode for a fuel cell, adding 1 to 60 parts by weight of carbon nanofibers with respect to 100 parts by weight of a catalyst to the catalyst slurry, the carbon nanofibers being in a slurry state, adding 1 to 20 parts by weight of a radical inhibitor with respect to 100 parts by weight of the catalyst to the catalyst slurry, the radical inhibitor being in a solid state, drying the final catalyst slurry prepared by adding the carbon nanofibers in a slurry state and the radical inhibitor in a solid state to the catalyst slurry and by stirring the mixture, thus forming an electrode; and thermally compressing the dried electrode on a polymer membrane.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In one embodiment, a first feature of the present invention is to add carbon nanofibers to a catalyst layer of an electrode for a fuel cell to increase the mechanical strength of the catalyst layer and to maintain the thickness of the catalyst layer after operation for a long time, thus suitably preventing a reduction in physical durability of the electrode for the fuel cell.

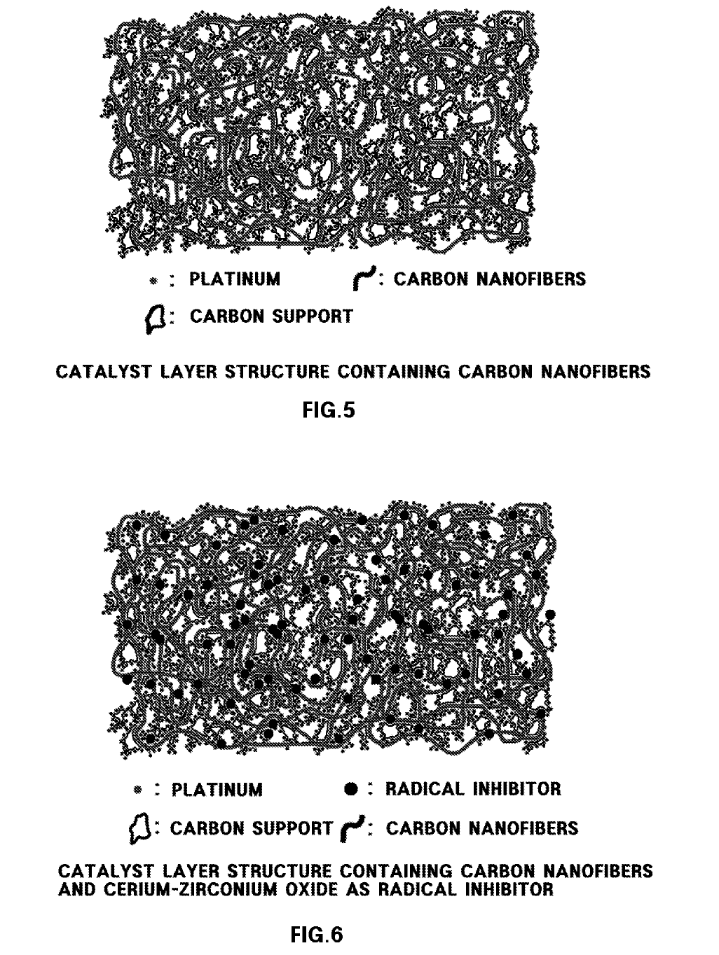

According to one exemplary embodiment and as shown in the conceptual diagram of FIG. 5, for example, the carbon nanofibers are added to the catalyst layer of the electrode for the fuel cell, i.e., the fuel electrode or air electrode, such that the carbon nanofibers suitably bind catalyst particles contained in the electrode, thus maintaining the strength of the catalyst layer and preventing the occurrence of cracks.

Preferably, the carbon nanotubes having the same mechanical properties may be used regardless of their types and include carbon nanotubes, carbon nanowires, carbon nanohorns, carbon nanorings, etc. Preferably, although various types of carbon nanofibers can be used, the carbon nanofibers having higher linearity produce a better effect.

Preferably, according to certain embodiments, the carbon nanofibers may have a diameter of 5 to 100 nm and a length of more than several hundred nanometers. In certain preferred embodiments, if the diameter is less than 5 nm, it is difficult to suitably disperse the carbon nanofibers, the carbon nanofibers are agglomerated after dispersion, and thus the catalyst slurry becomes non-uniform, whereas if the diameter is more than 100 nm, the ability to bind catalyst particles in the catalyst layer is reduced, and the carbon nanofibers may cause physical damage to the catalyst layer. Accordingly, in certain preferred embodiments, carbon nanofibers having a diameter of 5 to 100 nm are added to the catalyst layer.

Conventionally, carbon nanofibers having a diameter of more than 100 nm are used to form pores in the catalyst layer of the electrode for the fuel cell, unlike the present invention in which the carbon nanofibers having a diameter of 5 to 100 nm are added to bind catalyst particles in the catalyst layer.

In another preferred embodiment, a second feature of the present invention is to add cerium-zirconium oxide (CeZrO₄) as a radical inhibitor for inhibiting hydroxyl radicals to prevent a reduction in chemical durability of the electrode for the fuel cell.

For example, as shown in the conceptual diagram of FIG. 6, the cerium-zirconium oxide as a radical inhibitor is preferably added to the fuel electrode or air electrode together with the carbon nanofibers, such that the hydrogen peroxide produced in each electrode is decomposed with water molecules to inhibit the production of radicals, thereby preventing the decomposition of the polymer electrolyte.

Preferably, materials typically used as the radical inhibitor in the biochemical field may include at least one selected from the group consisting of cerium oxide, zirconium oxide, manganese oxide, aluminum oxide, vanadium oxide, and mixtures thereof, although are not necessarily limited as such.

According to certain preferred embodiments, in order to apply the oxides as radical inhibitors to the fuel cell, the oxides are suitably formed into nanoparticles having an average particle size of 2 to 60 nm and applied to the catalyst layer so as to inhibit the production of radicals and, at the same time, increase the chemical stability of the electrode and the polymer membrane. However, according to further exemplary embodiments, since the operating conditions of the fuel cell such as high temperature, high potential, etc., are severe, the durability of nanoparticles may be considerably reduced.

Accordingly, in order to physically stabilize the nanoparticles as radical inhibitors, a compound mixed with cerium and zirconium may preferably be used as the radical inhibitor. Preferably, the reason for this is that when the compound mixed with cerium and zirconium is used, the thermal stability of cerium nanoparticles is significantly suitably increased, and thereby the cerium nanoparticles are less deformed and agglomerated even under severe conditions.

A configuration of the electrode for the fuel cell in accordance with an exemplary embodiment of the present invention is described in more detail.

Preferably, the electrode for the fuel cell of the present invention comprises 20 to 80 parts by weight of a hydrogen ion conductive polymer electrolyte binder, 1 to 60 parts by weight of carbon nanofibers, and 1 to 20 parts by weight of a radical inhibitor with respect to 100 parts by weight of a carbon-supported catalyst.

In a further preferred embodiment, the carbon nanofibers may comprise at least one selected from the group consisting of carbon nanotubes, carbon nanofibers, carbon nanowires, carbon nanohorns, and carbon nanorings, which have a diameter of 5 to 100 nm. The reason for this is that if the diameter is less than 5 nm, it is difficult to disperse the carbon nanofibers, the carbon nanofibers are agglomerated after dispersion, and thus the catalyst slurry becomes non-uniform, whereas if the diameter is more than 100 nm, the ability to bind catalyst particles in the catalyst layer is reduced, and the carbon nanofibers may cause physical damage to the catalyst layer.

Further, according to certain exemplary embodiments, if the amount of carbon nanofibers used is less than 1 part by weight with respect to 100 parts by weight of the catalyst, it is difficult to bind catalyst particles in the catalyst layer, whereas if it is more than 60 parts by weight, the carbon nanofibers interfere with the mass transfer to clog the inlet and outlet of reactant gases, which reduces the performance of the fuel cell, and the amount of binder required is increased to cause unnecessary loss. Accordingly, the amount of carbon nanofibers used may be limited to 1 to 60 parts by weight.

Preferably, the radical inhibitor is formed into nanoparticles having an average particle size of 2 to 60 nm and applied to the catalyst layer so as to inhibit the production of radicals and, at the same time, increase the chemical stability of the electrode and the polymer membrane.

According to certain preferred embodiments, the radical inhibitor may be one selected from the group consisting of cerium oxide, zirconium oxide, manganese oxide, aluminum oxide, vanadium oxide, and mixtures thereof, although may not be limited as such. In certain embodiments, preferably, cerium-zirconium oxide may be used since the thermal stability of cerium nanoparticles is significantly increased, and thereby the cerium nanoparticles are less deformed and agglomerated even under severe conditions.

Here, if the amount of radical inhibitor used is less than 1 part by weight with respect to 100 parts by weight of the catalyst, the role as the radical inhibitor is insignificant, whereas if it is more than 20 parts by weight, the radical inhibitor interferes with the mass transfer to clog the inlet and outlet of reactant gases, which reduces the performance of the fuel cell, and the amount of binder required is increased to cause unnecessary loss. Therefore, the amount of radical inhibitor used may be limited to 1 to 20 parts by weight.

A method for forming a membrane-electrode assembly using the above-described electrode for the fuel cell according to preferred embodiments of the present invention is described in more detail.

According to preferred exemplary embodiments, first, a catalyst slurry is suitably prepared to form the electrode for the fuel cell of the present invention.

Preferably, the catalyst slurry is prepared by mixing a carbon-supported catalyst, a polymer electrolyte (in an amount of 20 to 80 parts by weight with respect to 100 parts by weight of the catalyst, and a solvent (selected from the group consisting of water, alcohol, and a mixture thereof). Further, 1 to 60 parts by weight of carbon nanofibers and 1 to 20 parts by weight of cerium-zirconium oxide as the radical inhibitor with respect to 100 parts by weight of the catalyst are added to the resulting mixture, thus preparing the final catalyst slurry.

Preferably, a platinum catalyst or platinum alloy catalyst containing platinum in an amount of 5 to 80 wt % is used as the catalyst.

According to further preferred embodiments, the catalyst is mixed with the solvent and completely dispersed by sonication and stirring. Preferably, the polymer electrolyte is added to the mixture and completely dispersed by repeated sonication and stirring. Further, the solvent is suitably evaporated under reduced pressure to provide appropriate solid content and viscosity such that the solid content of the catalyst slurry is 5 to 30 wt % with respect to the total weight of the catalyst slurry after evaporation of the solvent, thus maintaining an appropriate viscosity.

According to further preferred embodiments, the prepared catalyst slurry is suitably pulverized using a planetary bead mill to make the particle size of the catalyst smaller and more uniform. Preferably, beads having a diameter of 1 to 10 mm are used in an amount of 50 to 500 parts by weight with respect to 100 parts by weight of the catalyst slurry. Here, the pulverization process is performed at a rotational speed of 20 to 200 rpm for 0.1 to 5 hours.

According to preferred embodiments of the present invention, 1 to 60 parts by weight of carbon nanotubes as the carbon nanofibers with respect to 100 parts by weight of the catalyst are added to the catalyst slurry, in which the carbon nanotubes are also added in a slurry state.

Accordingly, to prepare a carbon nanotube slurry, the carbon nanotubes are suitably mixed with the same solvent as used during the preparation of the catalyst slurry, the same amount of polymer electrolyte is added to the mixture and completely dispersed by high energy sonication.

Preferably, the solid content of the thus prepared carbon nanotube slurry is measured such that an appropriate amount of carbon nanotube slurry is mixed with the catalyst slurry, and the mixture is subjected to the pulverization, sonication, and stirring processes.

Subsequently, the solvent is suitably evaporated under reduced pressure such that the solid content of the carbon nanotube slurry is 1 to 20 wt % with respect to the total weight of the carbon nanotube slurry after evaporation of the solvent.

According to preferred embodiments of the present invention, 1 to 20 parts by weight of cerium-zirconium oxide as the radical inhibitor with respect to 100 parts by weight of the catalyst are added in a solid state to the catalyst slurry.

Preferably, the cerium-zirconium oxide in a solid state is added to the catalyst slurry, and its adding method is not specifically limited.

Accordingly, the carbon nanotube slurry is added to the catalyst slurry, and the cerium-zirconium oxide in a solid state is added to the mixture and completely dispersed, thus preparing the final catalyst slurry.

In further preferred embodiment of the present invention, it is preferable that the solid content (which is the sum of catalyst, ionomer, carbon nanofibers, and cerium-zirconium oxide) of the thus prepared catalyst slurry be in the range of 5 to 30 wt % to have an appropriate viscosity and to be readily compressed during the formation of the membrane-electrode assembly.

Further, the final catalyst slurry is suitably coated on a release paper and dried at a temperature of 30 to 130° C., and the dried electrode is thermally compressed on a polymer membrane, thus forming the membrane-electrode assembly.

According to further exemplary embodiments, and in more detail, the dried electrode is suitably located on both ends of the polymer membrane and then subjected to thermal compression to form the membrane-electrode assembly. Accordingly, the thermal compression is performed at a temperature of 100 to 180° C. and a pressure of 50 to 300 kgf for 0.5 to 30 minutes. Preferably, after the thermal compression, the release paper is suitably removed to complete the formation of the membrane-electrode assembly.

The present invention according to exemplary preferred embodiments is described in more detail with reference to the following examples, but the present invention is not limited thereto.

### Examples 1 to 3

In a first exemplary embodiment, catalyst slurry was prepared by mixing 4 parts by weight of carbon nanotubes as one of the carbon nanofibers with respect to 100 parts by weight of the catalyst with a solvent in Example 1 (6 parts by weight of the carbon nanotubes were used in Example 2 and 8 parts by weight of the carbon nanotubes were used in Example 3), and adding 10 parts by weight of cerium-zirconium oxide as the radical inhibitor to the mixture. The prepared catalyst slurry was suitably coated on a release paper and dried, and the dried electrode was thermally compressed on a polymer membrane, thus forming a membrane-electrode assembly according to each example.

### Comparative Example

A conventional membrane-electrode assembly which contained no carbon nanofibers and radical inhibitor was adopted.

### Test Example 1

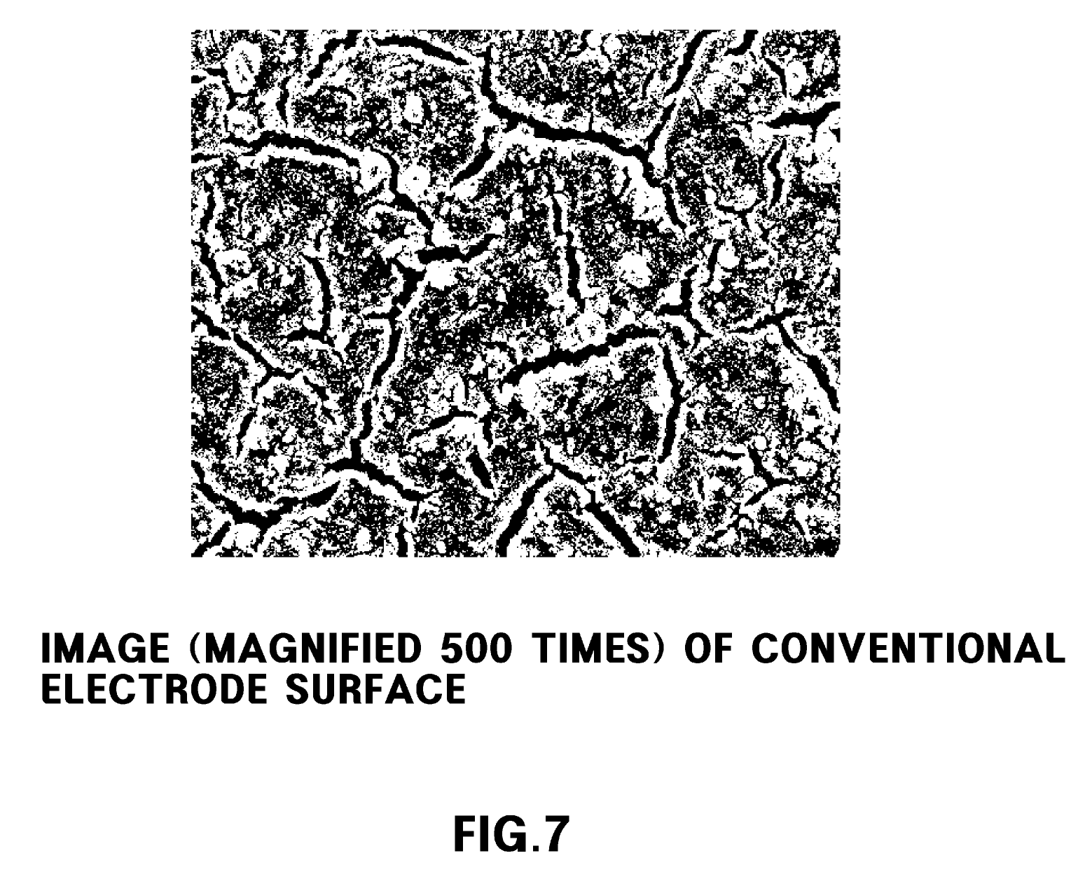

In another exemplary embodiment, the surfaces of the electrodes according to Examples 1 to 3 and the Comparative Example were photographed by an electron microscope to determine whether there were cracks, and the results are shown in FIGS. 7 to 12.

In the case of the method of forming a catalyst layer and transferring the catalyst layer on a polymer membrane, the catalyst layer may be cracked depending on the thickness of the catalyst layer, the content of a binder, and the type of catalyst. It can be seen from FIG. 7 that severe cracks were found in the catalyst layer according to the Comparative Example.

That is, in the case of the Comparative Example, the surface of the electrode was severely cracked, and thus the catalyst layer might be removed during the electrode transfer. Further, even in the case where the catalyst layer was transferred to the polymer membrane, cracks might be formed in the catalyst layer, and thus the polymer membrane might be exposed through the cracks, thereby significantly reducing the durability.

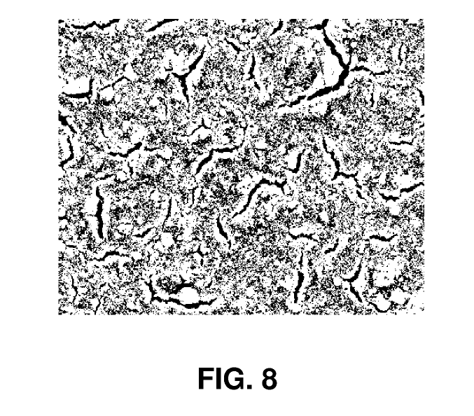

Moreover, it can be seen from FIG. 8 that the occurrence of cracks was suitably reduced in the surface of the electrode according to Example 1, in which 4 parts by weight of carbon nanofibers were added, and even a small amount of cracks were present.

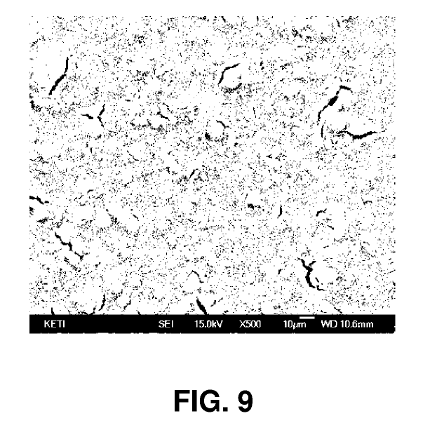

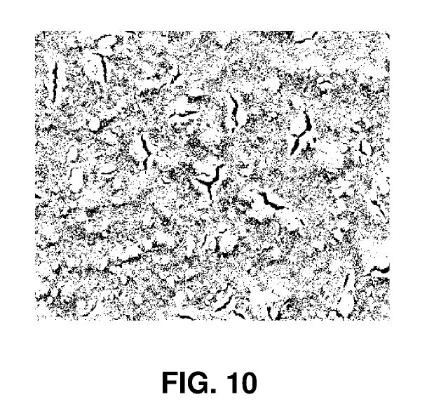

Further, it can be seen from FIGS. 9 and 10 that the occurrence of cracks was significantly reduced in the catalyst layers according to Examples 2, in which 6 parts by weight and 8 parts by weight of carbon nanofibers were added, respectively.

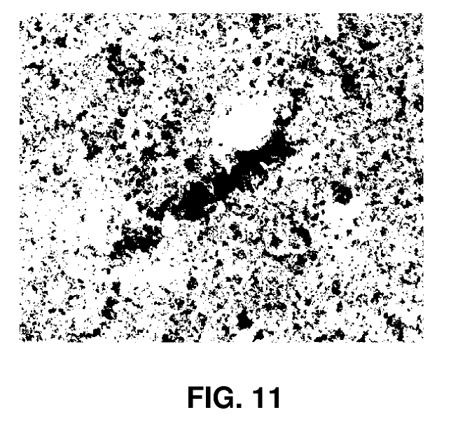

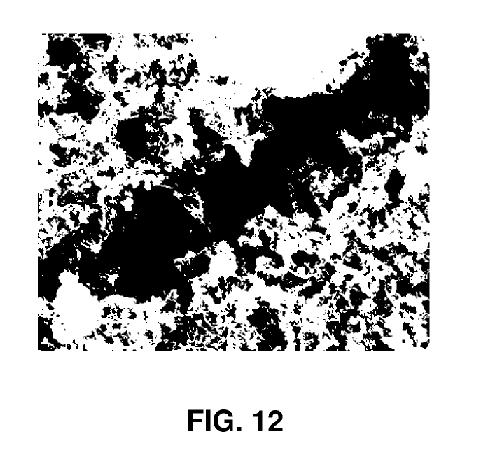

As a result, as shown in the image of FIG. 11, in which 6 parts by weight of carbon nanofibers were added, and as shown in the magnified image of FIG. 12, it can be seen that the carbon nanofibers around the cracks in the catalyst layer served to bind catalyst particles in the catalyst layer, thus preventing the occurrence of cracks.

### Test Example 2

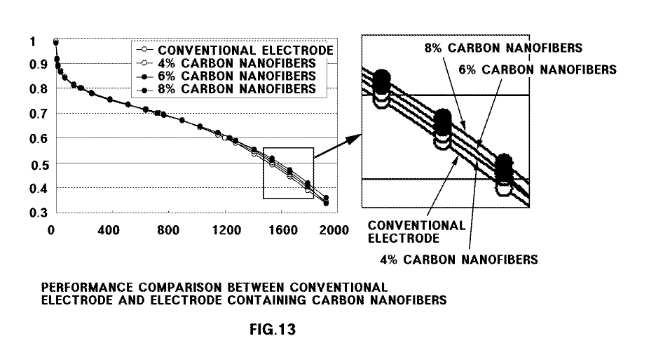

In another exemplary embodiment, the operational performances of the fuel cells were measured and compared with respect to the membrane-electrode assemblies according to the Examples and Comparative Examples, and the result are shown in FIGS. 13 to 15.

The measurement of durability was performed in such a manner that after the initial performance test, the performance was measured again after a predetermined time at an open circuit voltage (OCV) while maintain the unit cell temperature at 85° C. and the flow rate at 1 L/min (cathode: air, anode: hydrogen). Under these conditions, the production of radicals is suitably accelerated to promote the decomposition of the polymer electrolyte, and thus it is possible to determine the change in the durability of electrodes in a short time.

As shown in FIG. 13, it can be seen that the operational performances of the fuel cells including the electrode in which the carbon nanofibers were added according to the Examples of the present invention were slightly increased in a high current region compared to that of the Comparative Example.

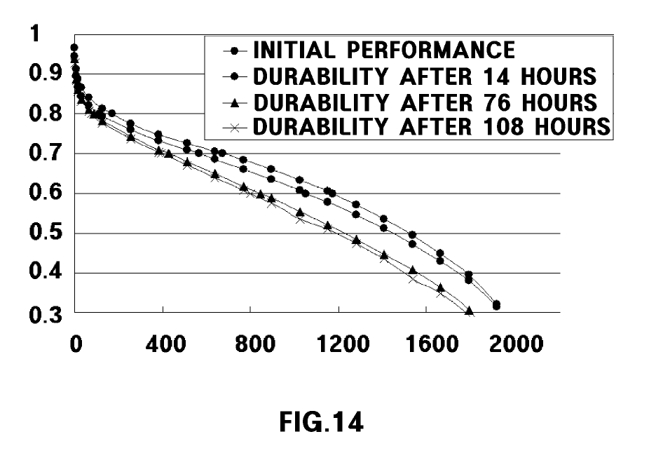

Moreover, as shown in FIG. 14, it can be seen that the durability of the electrode in which no radical inhibitor was added according to the Comparative Example was reduced 39% at the OCV after 108 hours compared to the initial performance.

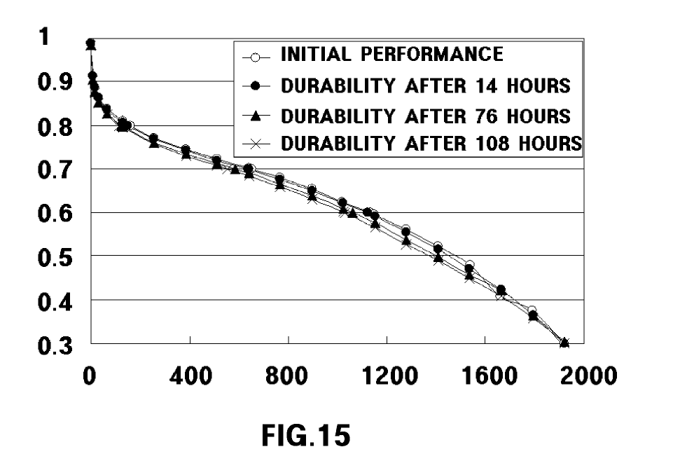

Furthermore, as shown in FIG. 15, it can be seen that the durability of the electrode in which the radical inhibitor was added according to the Examples of the present invention was reduced 10% even after 108 hours, from which it can be understood that the reduction in the durability was significantly improved.

As described above, the present invention provides the following effects.

According to the present invention, it is possible to suitably increase the mechanical strength of the catalyst layer and suitably maintain the thickness of the catalyst layer after operation for a long time by adding carbon nanofibers to the electrode catalyst layer of the fuel cell.

Further, it is possible to suitably minimize the reduction in performance after operation for a long time by adding cerium-zirconium oxide (CeZrO₄) as a radical inhibitor to the electrode catalyst layer to prevent the reduction in chemical durability of the fuel cell.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An electrode for a polymer electrolyte membrane fuel cell, the electrode comprising:
20 to 80 parts by weight of a hydrogen ion conductive polymer electrolyte binder with respect to 100 parts by weight of a catalyst;
1 to 60 parts by weight of carbon nanofibers; and
1 to 20 parts by weight of a radical inhibitor.

2. The electrode of claim 1, wherein the carbon nanofibers comprises at least one selected from the group consisting of carbon nanotubes, carbon nanowires, carbon nanohorns, and carbon nanorings, which have a diameter of 5 to 100 nm.

3. The electrode of claim 1, wherein the radical inhibitor has an average particle size of 2 to 60 nm and comprises at least one selected from the group consisting of cerium oxide, zirconium oxide, manganese oxide, aluminum oxide, vanadium oxide, and mixtures thereof.

4. The electrode of claim 1, wherein the catalyst is a platinum or platinum alloy catalyst supported on a catalyst support, the catalyst support comprising at least one selected from the group consisting of carbon powder, carbon black, acetylene black, ketjen black, activated carbon, carbon nanotubes, carbon nanofibers, carbon nanowires, carbon nanohorns, carbon aerogels, carbon cryogels, and carbon nanorings.

5. The electrode of claim 4, wherein the platinum or platinum alloy catalyst contains platinum in an amount of 5 to 80 wt %.

6. A method for forming a membrane-electrode assembly, the method comprising:
preparing a catalyst slurry to form an electrode for a fuel cell;
adding 1 to 60 parts by weight of carbon nanofibers with respect to 100 parts by weight of a catalyst to the catalyst slurry, the carbon nanofibers being in a slurry state;
adding 1 to 20 parts by weight of a radical inhibitor with respect to 100 parts by weight of the catalyst to the catalyst slurry, the radical inhibitor being in a solid state;
drying the final catalyst slurry prepared by adding the carbon nanofibers in a slurry state and the radical inhibitor in a solid state to the catalyst slurry and by stirring the mixture, thus forming an electrode; and
thermally compressing the dried electrode on a polymer membrane.

7. The method of claim 6, wherein the carbon nanofibers are carbon nanotubes added in an amount of 1 to 60 parts by weight with respect to 100 parts by weight of the catalyst and the radical inhibitor is cerium-zirconium oxide added in an amount of 1 to 20 parts by weight with respect to 100 parts by weight of the catalyst.

8. The method of claim 6, further comprising
pulverizing the catalyst slurry using a planetary bead mill to make the particle size of the catalyst smaller and more uniform.

9. The method of claim 6, wherein the final catalyst slurry has a solid content of 5 to 30 wt %, the solid content being a sum of catalyst, carbon nanofibers, radical inhibitor, and ionomer.

10. The method of claim 6, wherein the thermal compression is performed at a temperature of 100 to 180° C. and a pressure of 50 to 300 kgf for 0.5 to 30 minutes.
